(19) United States
(12) Patent Application Publication
(10) Pub. No.: US 2024/0260621 A1
(43) Pub. Date: Aug. 8, 2024

(54) LEGUMINOUS PROTEIN COMPOSITIONS HAVING IMPROVED ACID-GELLING PROPERTIES

(71) Applicant: ROQUETTE FRERES, Lestrem (FR)

(72) Inventor: Jennifer Louise KIMMEL, NILES, IL (US)

(21) Appl. No.: 18/563,098

(22) PCT Filed: May 25, 2022
(86) PCT No.: PCT/EP2022/064296

§ 371 Date: Nov. 21, 2023

Related U.S. Application Data
(60) Provisional application No. 63/192,752, filed on May 25, 2021.

(30) Foreign Application Priority Data
Jun. 7, 2021 (EP) 21305774.8

(51) Int. Cl. A23L 11/00; A23J 3/14; A23L 29/206

(52) U.S. Cl. CPC A23L 11/05; A23J 3/14; A23L 29/206

(57) ABSTRACT

The invention concerns a process of manufacturing a leguminous protein composition, leguminous protein compositions obtained by such a process and uses thereof in acid-gelling food products.

### TECHNICAL FIELD

The invention concerns a leguminous protein composition which has improved acid-gelling abilities.

### PRIOR ART

Daily human protein requirements are between 12 and 20% of the food ration. These proteins are supplied both by products of animal origin (meat, fish, eggs, dairy products) and vegetable origin (cereals, legumes, algae).

However, in industrialized countries, protein intake is mainly in the form of protein of animal origin. Numerous studies show that excessive consumption of proteins of animal origin to the detriment of vegetable proteins is one of the causes of increase in cancers and cardiovascular diseases.

In addition, animal proteins have many disadvantages, both in terms of their allergenicity, particularly concerning proteins from milk or eggs, and in environmental terms in relation to the harmful effects of intensive farming.

In a general manner, the use of vegetal proteins instead of animal protein has a favorable impact on the environment. Indeed, as final products are concerned, the use of vegetal proteins allows to use less energy and to generate much less greenhouse gas emissions.

Thus, there is a growing demand from manufacturers for ingredients of plant origin having advantageous nutritional and functional properties without, however, having the drawbacks of ingredients of animal origin.

Since the 1970s, interest in leguminous proteins has grown strongly, as an alternative protein resource to animal proteins intended for animal and human food. For example, pea contains about 27% by weight of protein content. Pea proteins, mainly pea globulin proteins, have been extracted and industrially valued for many years now.

However, compared to animal proteins, leguminous proteins are known to have less gelling properties than animal proteins such as the ones extracted from animal milk or eggs.

These protein compositions can be mixed in various food compositions. Food compositions can present very different pH, ranging from 3 to 9. There is an application field where high gelling properties have strong interest: the field of acid-gelling food products. By “acid-gelling food product”, it is meant an acidic food which develops gelling properties during acidification. Acid-gelling food products include for example yogurts, cheeses and acidic sauces (mayonnaise, ketchup, etc. . . . ).

To manufacture an acidic set or stirred yogurt starting from a protein milk, it is needed that the yogurt increases viscosity and forms a gel during the acidification by fermentation using microorganisms. In that sense, the phenomenon of acid-gelling is very different from the phenomenon of thermal gelling, i.e. the phenomenon of protein gelling induced by a thermal treatment. In the case of yogurt, to maintain the benefit of the probiotics present in a fermented product, it is important that no thermal treatment occurs at the end of the process, after the formation of the gel. When manufacturing yogurts, the gelling properties of the proteins are developed during acidification of the yogurt, this acidification being caused by the use of probiotic microorganisms. The decrease of pH induces the precipitation of the proteins and their aggregation. The consequent microstructure determines the texture and the high viscosity of the resulting gelled yogurt product.

One other property related to acid-gelling is the stability of the gel: it is also important that the food product shows good water stability, i.e. that there is limited phenomenon of syneresis. Syneresis reflects the disability of a gel to bind and hold water both during acidification and once the final gel is formed.

However, leguminous proteins and especially pea proteins are generally considered as having weaker acid-gelling properties than animal milk proteins, which consist mainly in a blend of whey and casein. Therefore, the low acid-gelling properties of the leguminous proteins, especially pea proteins, cause issues when manufacturing acid-gelling food products. It is thus important to provide new leguminous protein compositions having higher acid-gelling properties than the pea protein alone in order to facilitate the manufacture of the acid-gelling food products.

To provide vegetable-based acid-gelling food products having improved texture and viscosity, it has been proposed to use, in combination of ingredients comprising proteins, additives to mimic the gel to the acid-gelling foods. Such gelling additives include gums such as xanthan gums, or pectins such as low-methoxy pectins which are generally prepared from ‘waste’ citrus peel and apple pomace. However, these additives are not fully satisfactory in terms of nutritional benefits and these products are generally not considered as “clean-label” additives. Another solution is to use in combination with the protein, a pregelatinized starch: the viscosity and gel texture is then provided by the pregelatinized starch that presents some gel properties at acidic pH.

For example, in the field of acidic sauces, WO2014/001030 describes an emulsion, such as a mayonnaise sauce, that comprises pulse albumin in the form of finely grinded flour, pregelatinized starch and xanthan gum or pectins. Another solution to provide such kind of mayonnaise sauce is described in the unpublished patent application PCT/FR2021/050748, which describes the use of a blend of leguminous albumins and pregelatinized starch to manufacture vegan mayonnaise sauce.

In the field of yogurts, the need of acid-gelling properties is also important and WO2017/185093 describes different recipes of yogurts obtained from the fermentation of a milk comprising pea protein. Similarly, document WO2019/069111 also describes a process that uses a step of heating of a pea protein milk before inoculating the obtained mixture with lactic acid bacteria in order to provide a non-dairy fermented food product, having substantially no added stabilizers, with a determined viscosity and firmness. The processes described above need extra care and are complex. Moreover, most of the time, when using the pea proteins of the market, the described processes do not allow to reach the properties desired for the yogurt, and high level of syneresis and/or low gelling properties are observed.

It appears from the above that it would be helpful to provide leguminous protein compositions able to have high acid-gelling properties, in order to facilitate the manufacture of acid-gelling foods based on leguminous proteins and/or without needing the addition of gelling additives, such as low methoxy pectins.

### DESCRIPTION OF THE INVENTION

It is one of the achievements of the invention to provide a new leguminous protein composition presenting improved acid-gelling abilities. Indeed, during her investigations, the inventor has surprisingly observed that it was possible to improve the acid-gelling ability of the leguminous protein by incorporating a cooked leguminous fiber into the leguminous protein. The invention has the further advantage to use clean label ingredients from leguminous-based materials instead of using gelling additives such as low methoxy pectins.

The invention concerns a process of manufacturing a leguminous protein composition comprising:
providing a leguminous protein (a),
providing a cooked leguminous fiber (b),
blending the cooked leguminous fiber (b) with the leguminous protein (a) to form the leguminous protein composition,
   wherein the weight ratio a:b in dry weight is between 99:1 and 80:20.

The process allows to increase the gelling properties of the leguminous protein composition when used in acid-gelling food products. As demonstrated in the examples, this leguminous protein composition especially presents improved acid-gelling properties compared to a same composition differing only in that the leguminous fiber is not cooked or compared to a leguminous protein (a) that does not comprise any leguminous fiber (b) at all.

The mechanism by which said cooked leguminous fiber improves the gel strength of the leguminous protein under acidic conditions is still unknown. Without wishing to be bound to any theory, one hypothesis can be based on electrostatic interactions between the more positively charged leguminous protein and the more negatively charged soluble components of the leguminous fiber. These electrostatic attractive forces form soluble complexes between the leguminous protein and the soluble components of the leguminous fiber, resulting in a higher proportion of soluble complexes compared to insoluble aggregates. This higher proportion induces a stronger overall gel matrix and an increase in the measurable gel strength at acid pH. Additionally, the water is more strongly associated with the gel matrix resulting in a decrease in the syneresis of the acid gel. To obtain these interactions, the inventor has found that it was needed to cook the leguminous fiber, the uncooked leguminous fiber did not allow to obtain such improvements, as demonstrated in Example 4 in the Examples section.

Thus, another object of the invention concerns a leguminous protein composition, that can be obtained by the process of the invention.

Another object of the invention concerns the use of the composition of the invention in acid-gelling food products, such as yogurts, cheeses or acidic sauces.

By “leguminous protein” and “leguminous fiber”, it is respectively meant a protein and a fiber extracted from leguminous plant. For the purposes of the present invention, the term “leguminous plants” means any plants belonging to the family Cesalpiniaceae, the family Mimosaceae or the family Papilionaceae, and in particular any plants belonging to the family Papilionaceae. It can be for instance pea, fava bean, mung bean, lentil, alfalfa, soybean or lupin bean. Preferably, said leguminous plant is chosen from the group consisting of pea, fava bean and mung bean. Even more preferably, said leguminous plant is pea. In a preferred embodiment, said leguminous plant is soybean.

According to the invention, the term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present application, the term “pea” includes the varieties of pea belonging to the Pisum genus and more particularly Pisum sativum.

Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

In a preferred embodiment, the pea is derived from smooth pea, in particular yellow smooth pea.

In one embodiment of the invention, the same leguminous plant is used for protein (a) and cooked fiber (b). For example, one embodiment of the invention concerns a pea protein composition comprising a pea protein (a) and a cooked pea fiber (b) or a fava bean protein composition comprising a fava bean protein (a) and a cooked fava bean fiber (b).

In another embodiment of the invention, the leguminous protein composition can also comprise leguminous protein (a) and cooked leguminous fiber (b) of leguminous plants that are different from one another: for example, the leguminous protein composition of the invention can be a fava bean protein composition comprising a fava bean protein (a) and a cooked pea fiber (b).

In the following of the description, the invention will be detailed for an embodiment where both leguminous protein (a) and cooked leguminous fiber (b) are both from pea. However, any leguminous plant in the invention can be used and the term “pea” is interchangeable with any leguminous plant cited above. It can be for instance, instead of pea, chosen from fava bean, mung bean, lentil, alfalfa, soybean or lupin bean. In one embodiment, the leguminous protein (a) is a soybean protein and the cooked leguminous fiber (b) is a cooked pea fiber.

By “pea protein composition”, it is meant a composition comprising essentially pea protein (a) as the only source of protein. In other words, the pea protein composition does not comprise any significant amount of protein that comes from another origin than pea.

The process of the invention comprises a step of providing the pea protein (a).

Proteins are large biomolecules, or macromolecules, consisting of one or more long chains of amino acid residues. Like all leguminous-plant proteins, pea proteins consist of three main classes of proteins: globulins, albumins and “insoluble” proteins. In a preferred embodiment, the pea protein comprises mainly pea globulins, i.e. pea globulins are the major protein. Generally, the pea protein (a) comprises at least 50% of pea globulins based on the dry weight of the total pea protein, preferably at least 75%.

The pea protein (a) generally presents a richness of at least 50%. The richness is according to the present application the percentage by weight of protein N6.25 based on the total dry weight of the pea protein. Advantageously, the richness of the pea protein (a) is at least 80%, preferably of at least 85%. According to the present invention, the pea protein (a) may be a pea protein isolate or a pea protein concentrate. Pea protein isolates have generally a richness of at least 80% whereas pea protein concentrates have generally a richness going from 50% to 80%. The percentage by weight of protein N6.25 (i.e. richness) can be determined using the DUMAS method according to standard ISO 16634.

Different processes to obtain the pea protein (a) from pea flour exist and can be used. This process can be a dry process or a wet process. Dry process comprises a step of milling pea to form pea flour and at least one step of fractionation of the pea flour, generally by air classification or by sieving, the finer fraction obtained being richer in protein. Generally, the wet process to obtain pea protein comprises a step of providing a suspension of flour of dehulled peas in water, at least one step of separation to remove insoluble starch and fiber from the suspension to obtain a soluble protein-rich liquid fraction and a step of isolation of the pea proteins. The suspension of flour can be obtained by dry grinding or wet grinding of the peas. The separation step can be done using separation devices such as hydrocyclones, decanters, centrifugators or combination thereof. The step of isolation can contain a step of precipitation of the proteins at the isoelectric point followed by a step of centrifugation or a step of filtration using membrane. The manufacturing of such pea protein isolates are described for example in WO2007/017572, WO2011/124862 or WO2019/053387. The pea protein (a) can also be the co-spray dried pea proteins described in document WO2020/240144.

The pea protein (a) can be in a powder form or in the form of a liquid solution. In the case of liquid solution, the solution is generally an aqueous liquid solution. Powder forms may be obtained after drying of a pea protein solution, with methods such as freeze drying or spray drying.

As pea protein (a), commercial products such as the ones commercialized by the applicant under the brand NUTRALYS® can be used, such as NUTRALYS®S85F or NUTRALYS®F85M.

Typically, the pea protein (a) can be obtained resuspending pea flour in water, extracting the soluble material by centrifugation, heating at 60° C. at an acidic pH and subjecting to a further centrifugation in order collect the underflow comprising pea protein.

In a preferred embodiment, the pea protein is denaturated, ie. subjected to a further heat treatment step, for example at a temperature going from 75 to 150° C. for a time sufficient to obtain denaturation, such as a step at 85° C. for 10 minutes. Preferably, further heat treatment step takes place after neutralization of the protein, at a pH around 6.5 to 7.5. Denaturation of the protein can be assessed by any suitable method, such as differential scanning calorimetry as described below in Example 8.

Preferably, the pea protein (a) is not hydrolyzed. Preferably, the pea protein (a) has a degree of hydrolysis below 6, for example between 3 and 5.5. The degree of hydrolysis of a protein is representative of the length of the amino-acids chains in the protein. The DH is known by the skilled person in the art and different methods exist to determine it. The degree of hydrolysis DH can be determined using the following equation:

$$DH = \frac{Amino nitrogen ( \% ) \times 100}{Protein nitrogen ( \% )}$$

in which the protein nitrogen is determined according to the DUMAS method according to standard ISO 16634 and amino nitrogen is determined using the MEGAZYME kit (reference K-PANOPA).

The process of the invention also comprises a step of providing a cooked pea fiber (b).

The cooked pea fiber (b) useful to the invention can be obtained by a process comprising a step of cooking a suspension of a pea fiber material and optionally a step of removing the insoluble fraction from the cooked pea fiber. This optional step allows to extract a soluble fraction of the cooked pea fiber. Thus, by “cooked pea fiber”, it is meant a product obtained by cooking a suspension of a pea fiber material or a soluble fraction of this product. By “whole cooked pea fiber”, it is meant a product obtained by cooking a suspension of a pea fiber material that is not subjected to the optional step of removing the insoluble fraction. By “soluble cooked pea fiber”, it is meant a product obtained by cooking a suspension of a pea fiber material that is subjected to at least one step of removing the insoluble fraction.

A pea fiber material is prepared from pea. In an industrial viewpoint, the pea fiber material is a fraction obtained from pea flour, and then separating and removing starch and protein fractions. The same means of separation as the ones cited previously for obtaining pea protein can be used. Preparation of pea fiber are described for example in documents US20040091600 and US20180116261A1. This pea fiber material is also known as “internal pea fiber”. Available pea fibers commercial products are for example Roquette® Pea Fiber 150M, Emfibre from Emsland or Swelite from Cosucra.

The pea fiber material can comprise a fiber content in an amount of at least 35% and of at most 80% of total dietary fibers by weight on the basis of the dry matter assayed by the method AOAC 2017.16, more preferably in an amount of between 40% and 55% fibers. The pea fiber material generally comprises starch. Starch can be present in the pea fiber material such that the pea fiber material presents a dry weight ratio total dietary fiber/total starch between 30/70 and 85/15, more preferably between 40/60 and 70/30. Starch content is total starch content and can be determined using AOAC 996.11. Generally, the pea fiber material comprises at least 80% of total starch and total fiber, preferably at least 85%.

In the present document, the “suspension of a pea fiber material” means a blend of a liquid and of the pea fiber material. The dry matter of the suspension will depend and be adapted to the apparatus used for cooking the pea fiber material. The apparatus can be for example an autoclave reactor or an extruder. The suspension generally has a dry matter ranging from 5 to 15%, for example from 6 to 10%. The suspension is advantageously an aqueous suspension.

During the cooking step, the pH of the suspension can be from 3 to 12, for example from pH 4 to pH 10 because a hydrolysis of fiber is promoted under the acidic condition at less than pH 3 and a decomposition of fiber is promoted under the alkaline condition, especially when pH is more than 12. The suspension can have advantageously a pH going from 4 to 6, preferably from 4.5 to 5.5, even more preferably around 5. The suspension can have advantageously a pH going from 6 to 8, preferably from 6.5 to 7.5, even more preferably around 7. The suspension can have advantageously a pH going from 8 to 10, preferably from 8.5 to 9.5, even more preferably around 9. There is no limitation on the acid and alkali used. For example, acid such as hydrochloric acid, sulfuric acid, phosphoric acid, citric acid, tartaric acid, acetic acid and formic acid, and alkali such as sodium hydroxide, calcium hydroxide, potassium hydroxide, sodium bicarbonate, sodium carbonate, and ammonia may be used. The step of cooking the suspension of the pea fiber material can be done at a temperature ranging from 60 to 200° C., for example from 70 to 150° C., preferably from 90 to 140° C., more preferably 110 to 135° C. or 120° to 135° C. The cooking time may be adjusted depending on the temperature, generally ranging from 10 minutes to 300 minutes, for example from 12 to 150 minutes. Preferably, the cooking time is from 15 to 100 minutes, most preferably from 20 to 60 minutes. In one embodiment, the cooking step is done at a temperature of 120° C. Typically, the cooking step is done at a temperature of 120° C. for 20 minute, 30 minutes, 60 minutes or 90 minutes. In another embodiment, the cooking step is done at a temperature of 135° C. for 20 minutes.

For the optional step of removing the insoluble fraction, any efficient separation step can be used. It can be done for example by using decantation, centrifugation or filtration, advantageously using centrifugation. Centrifugation can be done for example by using a disc-centrifuge. Filtration can be conducted for example by using a filter press.

In the process to obtain the cooked pea fiber, it is possible to decrease the amount of starch in the cooked pea fiber even further by using a step of removal of starch. Examples of the methods of removal of starch include degradation with an amylase or cooling precipitation (retrogradation of the starch fraction of the cooked pea fiber) followed by separation, preferably using filter press. Examples of a method of removal of starch with an amylase are the use of amylase during, before or after the step of cooking. This amylase treatment can be done before or after the optional step of removing the insoluble fraction from cooked pea fiber.

During the cooking step of the pea fiber material, at least a part of the starch present is gelatinized. In a preferred embodiment, the cooked pea fiber (b) comprises a content of gelatinized starch, based on the content of total starch of the cooked pea fiber, of at least 80%, for example of at least 90%. The content of gelatinized starch of a sample can be determined using AACC Method 76-31.01, Determination of Damaged Starch—Spectrophotometric Method. The content of the total starch is determined by AOAC 996.11.

In a preferred embodiment, the cooked pea fiber comprises a content of ethanol-soluble fiber, as determined by AOAC 2017-16 and referred as SDFS in the method, below 50%, for example below 40%, for example below 30%, for example below 20%, for example below 9%, for example below 7%, for example below 5%, for example below 3%.

In another preferred embodiment, the cooked pea fiber (b) is obtainable by cooking a suspension of at least a portion of the pea fiber material, wherein the pH is between 4 and 6, preferably between 4.5 and 5.5 during 10 minutes to 300 minutes, for example from 12 to 150 minutes, preferably from 15 to 100 minutes, most preferably from 20 to 60 minutes, at a temperature ranging from 90 to 140° C., more preferably 110 to 135° C.

In another preferred embodiment, the ethanol-soluble fiber residue obtained after conducting AOAC-2017.16 fiber determination assay of the cooked pea fiber (b) comprises a content of saccharides having a degree of polymerization of DP<10, expressed in dry mass content based on the total dry mass of ethanol-soluble fiber residue, of 6% or more, for example from 10 to 50%, or from 10 to 40%, or from 10 to 35%, or from 12 to 30%, or from 15 to 25%. These contents can be determined by high performance liquid chromatography (HPLC) on ion-exchange resin. The HPLC apparatus can be equipped with a styrene divinylbenzene ion-exchange resin column in silver form, for example a column of Bio-Rad HPX 42A type, and with a refractive index detector. A more detailed method can be found in the Examples section.

Regarding the cooked pea fiber (b), it can be in a liquid form, the liquid being viscous or not, or in a solid form, for example in a powder form. It can thus have a dry matter going for example from 5 to 100%. The dry matter can be chosen by applying the methods known in the art such as concentration under vacuum or drying. The cooked pea fiber (b) can be put in powder form by using the methods known in the art such as drum drying or spray drying.

The process of the invention also comprises a step of blending of the pea protein (a) and the cooked pea fiber (b). This blending of (a) and (b) can be dry blending or blending in a liquid media, especially in water.

Preferably, the pea protein composition of the invention is in a powder form.

Preferably, especially when pea protein composition in a powder form, the dry matter of the pea protein composition is between 90 and 100%.

According to an embodiment, the pea protein composition is in a powder form and is obtainable by the dry blending of a powder of the pea protein (a) and a powder of the cooked pea fiber (b).

According to another embodiment the pea protein composition is in a powder form and is obtainable by co-atomization of a liquid containing the pea protein (a) and a liquid containing the cooked pea fiber (b) or by atomization of a liquid containing the pea protein (a) and the cooked pea fiber (b).

To blend pea protein (a) and cooked pea fiber (b), any kind of adapted blender may be used. Adapted blender for blending in a liquid media can be a homogenizer or a high-speed shear pump. Generally, the process to manufacture the pea protein composition does not comprise any extrusion step, and in particular does not comprise a step of extrusion cooking after the blending step.

According to the invention, the weight ratio a:b, expressed in dry weight, ranges from 99:1 to 80:20. The weight ratio a:b, expressed in dry weight is advantageously from 97:3 to 87:13, preferably from 95:5 to 90:10.

In one preferred embodiment, the process of the invention comprises:
a step of providing a suspension of flour of dehulled peas in water,
a step of extracting of a starch rich fraction,
a step of extracting of a pea fiber material,
a step of extracting of a soluble protein-rich liquid fraction,
a step of isolation of the pea proteins from the protein-rich liquid fraction, preferably by precipitation of the proteins at the isoelectric point followed by centrifugation,
a step of cooking a suspension of at least a portion of the pea fiber material,
a step of blending the cooked pea fiber or a portion of the cooked pea fiber with the isolated pea proteins to form the pea protein composition,
optionally a step of heat treatment of the pea protein composition,
optionally a step of drying of the pea protein composition.

According to one embodiment of the invention, the process does not comprise any use of organic solvent during the process.

The gelling and syneresis properties of the final protein composition depend on the ratio above: generally, the more cooked pea fiber is in the composition, the better the properties are. However, in order to obtain a protein composition that has a higher protein richness, it is preferable that the weight ratio a:b, expressed in dry weight is 90:10 or higher.

The pea protein composition of the invention has advantageously a richness in proteins, on a dry weight basis, above 75%, for example above 80%, advantageously above 82%, preferably above 85%.

The pea protein composition can comprise a total starch content between 0 and 10%, for example between 0.5 and 5%, as determined using AOAC 996.11 indicated above.

The pea protein composition can comprise a total dietary fiber content between 0 and 20%, generally between 1 and 18%, for example between 5 and 15%, as determined using the AOAC Method 2017.16 indicated above.

According to one embodiment of the invention, the pea protein composition comprises a blend of pea protein (a) and cooked pea fiber (b) wherein the weight ratio a:b in dry weight is between 99:1 and 80:20 and wherein the ethanol-soluble fiber residue obtained after conducting AOAC-2017.16 fiber determination assay of the cooked pea fiber b) comprises a content of saccharides having a degree of polymerization of DP<10, expressed in dry mass content based on the total dry mass content of said ethanol soluble fiber residue, of 6% or more, for example from 10 to 50%, or from 10 to 40%, or from 10 to 35%, or from 12 to 30%, or from 15 to 25%. Alternatively, the pea protein composition comprises a blend of pea protein (a) and cooked pea fiber (b) wherein the weight ratio a:b in dry weight is between 99:1 to 80:20 and wherein the cooked pea fiber (b) comprises a content of gelatinized starch, based on the content of total starch of the cooked pea fiber, of at least 80%, for example of at least 90% and comprises a content of ethanol-soluble fiber, as determined by AOAC 2017-16, below 50%, for example below 40%, for example below 30%, for example below 20%, for example below 9%, for example below 7%, for example below 5%, for example below 3%.

The pea protein composition can also comprise further components that are generally present in the pea protein and pea fiber materials, such as other carbohydrates, lipids or minerals. These components are however present in relatively small amounts compared to the total amount of protein and fiber. For example, the pea protein composition typically comprises less than 10% total starch, expressed by dry weight based on the total dry weight of the composition, preferably less than 9%, even more preferably less than 8%, 7%, 6%, or 5%.

In one embodiment, the leguminous protein composition consists essentially of the blend of leguminous protein (a) and cooked leguminous fiber (b). In other terms, no other component is added to this blend in order to obtain the leguminous protein composition.

The pea protein composition presents improved acid-gelling properties. According to the invention, acid-gelling properties can include storage modulus as determined when using a TEST A. According to the invention, acid-gelling properties can include syneresis percentage as determined as when using a TEST B.

One of the advantages of the invention is that the protein composition can be an acid-gelling pea protein composition that has high gelling properties when put at acidic pH. By “acid-gelling protein composition”, it is meant a protein composition having a storage modulus of at least 500 Pa when determined using a TEST A.

The acid-gelling pea protein composition can have a storage modulus of at least 800 Pa when determined using a TEST A, advantageously at least 1000 Pa, or at least 1100 Pa, or at least 1200 Pa, or at least 1300 Pa, or at least 1400 Pa, or at least 1500 Pa, or at least 1600 Pa, or at least 1700 Pa, or at least 1800 Pa, or at least 1900 Pa, or at least 2000 Pa, or at least 2100 Pa, or at least 2200 Pa, or at least 2300 Pa, or at least 2400 Pa. In another preferred embodiment of the invention, the pea protein composition has a storage modulus of at least 2500 Pa when determined using a TEST A, advantageously at least 3000 Pa, preferably at least 3500 Pa, more preferably at least 4000 Pa, even more preferably at least 4500 Pa, most preferably at least 5000 Pa.

Details of how to carry out the TEST A and determine the storage modulus (G′) can be found in the example section.

In addition, the determination of gel strength ratio using a TEST A is provided in the Example section. The gel strength ratio consists in the ratio between the storage modulus (G′) of the protein composition of the invention and the storage modulus (G′) of the protein (a). It therefore reflects the improvement of the gel strength (or storage modulus) which is obtained by blending the protein (a) with the cooked fiber (b).

According to the invention, the process of the invention can lead to a gel strength ratio, as determined using TEST A, of at least 1.1, preferably at least 1.3, most preferably at least 1.35, for example going from 1.35 to 2.70, for example going from 1.40 to 2.70, for example going from 1.50 to 2.70, for example going from 1.70 to 2.70, for example going from 1.80 to 2.50, for example going from 1.90 to 2.30.

One other important aspect of the acid-gelling properties of the protein composition is its ability to bind and hold water both during acidification and once the final gel is formed, i.e. the syneresis.

One of the advantages of the invention is that it is possible to obtain pea protein compositions that present low syneresis properties when these are put in acidic conditions. In another preferred embodiment of the invention, the pea protein composition has a percentage of syneresis below 7% when determined using a TEST B, advantageously below 5%, preferably below 4%, more preferably below 3%, even more preferably below 2%, most preferably below 1%.

Details of how to perform the TEST B and determine the percentage of syneresis can be found in the example section.

In addition, the determination of syneresis ratio using a TEST B consists in the ratio between the percentage of syneresis of the protein composition of the invention and percentage of syneresis of the protein (a). It therefore reflects the improvement of the syneresis properties which is obtained by blending the protein (a) with the cooked fiber (b).

According to the invention, the process of the invention can lead to a syneresis ratio using TEST B below 0.8, preferably below 0.6, most preferably between 0.05 and 0.6, for example between 0.05 and 0.3.

In general terms, the pea protein composition of the invention can be used in food and beverage products that may include the pea protein composition in an amount of up to 100% by weight relative to the total dry weight of the food or beverage product, for example in an amount of from around 1% by weight to around 80% by weight relative to the total dry weight of the food or beverage product. All intermediate amounts (i.e. 2%, 3%, 4% . . . 77%, 78%, 79% by weight relative to the total weight of the food or beverage product) are contemplated, as are all intermediate ranges based on these amounts. Food or beverage products which may be contemplated in the context of the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cookies, cakes, pastries, confectionary products and the like, such as fat-based cream fillings); desserts, gelatins and puddings; frozen desserts (including, but not limited to, frozen dairy desserts such as ice cream—including regular ice cream, soft serve ice cream and all other types of ice cream—and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters, fruit juice and sweet tea or coffee based beverages); beverage concentrates (including, but not limited to, liquid concentrates and syrups as well as non-liquid ‘concentrates’, such as freeze-dried and/or powder preparations); yogurts (including, but not limited to, full fat, reduced fat and fat-free dairy yogurts, as well non-dairy and lactose-free yogurts and frozen equivalents of all of these); snack bars (including, but not limited to, cereal, nut, seed and/or fruit bars); bread products (including, but not limited to, leavened and unleavened breads, yeasted and unyeasted breads such as soda breads, breads comprising any type of wheat flour, breads comprising any type of non-wheat flour (such as potato, rice and rye flours), gluten-free breads); pre-made bread mixes for preparing bread products; sauces, syrups and dressings; sweet spreads (including, but not limited to, jellies, jams, butters, nut spreads and other spreadable preserves, conserves and the like); confectionary products (including, but not limited to, jelly candies, soft candies, hard candies, chocolates and gums); sweetened and un sweetened breakfast cereals (including, but not limited to extruded breakfast cereals, flaked breakfast cereals and puffed breakfast cereals); and cereal coating compositions for use in preparing sweetened breakfast cereals. Other types of food and beverage product not mentioned here but which conventionally include one or more nutritive sweetener may also be contemplated in the context of the present invention. In particular, animal foods (such as pet foods) are explicitly contemplated. It can also be used, eventually after texturization by extrusion, in meat-like products such as emulsified sausages or plant-based burgers. It can also be used in egg replacement formulations.

The food or beverage product can be used in specialized nutrition, for specific populations, for example for baby or infants, elderly people, athletes, or in clinical nutrition (for example tube feeding or enteral nutrition).

The pea protein composition can be used as the sole source of protein but also can be used in combination with other plant or animal proteins. The term “plant protein” denotes all the proteins derived from cereals, oleaginous plants, leguminous plants and tuberous plants, and also all the proteins derived from algae and microalgae or fungi, used alone or as a mixture, chosen from the same family or from different families. In the present application, the term “cereals” is intended to mean cultivated plants of the grass family producing edible grains, for instance wheat, rye, barley, maize, sorghum or rice. The cereals are often milled in the form of flour, but are also provided in the form of grains and sometimes in whole-plant form (fodders). In the present application, the term “tubers” is intended to mean all the storage organs, which are generally underground, which ensure the survival of the plants during the winter season and often their multiplication via the vegetative process. These organs are bulbous owing to the accumulation of storage substances. The organs transformed into tubers can be the root e.g. carrot, parsnip, cassava, konjac), the rhizome (e.g. potato, Jerusalem artichoke, Japanese artichoke, sweet potato), the base of the stalk (more specifically the hypocotyl, e.g. kohlrabi, celeriac), the root and hypocotyl combination (e.g. beetroot, radish). The animal protein can be for example egg or milk proteins, such as whey proteins, casein proteins or caseinate. The pea protein composition can thus be used in combination with one or more of these proteins or amino acids in order to improve the nutritional properties of the final product, for example to improve the PDCAAS of the protein or to bring other or modify functionalities.

The pea protein composition of the invention is particularly helpful for acid-gelling food products.

One further aspect of the invention is thus the use of the pea protein composition in acid-gelling food products, such as yogurts, cheeses or acidic sauces.

One further aspect of the invention is also a method of improving the acid-gelling properties of a food product, the food product comprising the pea protein composition.

In an embodiment, acid-gelling food products can have a pH of 3 to 6 when diluted at a dry matter of 10%. The pea protein composition can be used to form a milk, which is fermented and/or acidified to provide yogurts and cheeses. These milks can present a dry matter going from 5 to 30%. These milks can comprise other components such as sugars, fats and optional ingredients. Yogurts can include stirred yogurts, set yogurts or yogurts to drink. These can be flavoured or not and can include other components such as fruit preparations and/or sweeteners. Cheeses can be analogues of process cheese, swiss cheese, string cheese, ricotta, soft-rippened cheeses such as camembert, Munster or brie, provolone, parmesan, mozzarella, jack, manchego, blue, fontina, feta, edam, double Gloucester, cheddar, asiago and Havarti. Acidic sauces are for example mayonnaise or ketchup. All these food-products can be vegan food products or can comprise some amount of ingredients from animal origin.

In another aspect, the invention relates to the use of a cooked leguminous fiber as described above, preferably a cooked pea fiber, in acid-gelling food products. Typically, said acid-gelling food product contains a leguminous protein. Advantageously, the food product can be devoid of gelling additives such as low methoxy pectins.

The invention encompasses the different embodiments described above and all their combinations. Especially, when the above description discloses different ranges of one criteria, it explicitly encompasses all the ranges coming from the combinations of the different lower ends of the ranges with the different higher ends of the ranges. The invention is now going to be detailed in the Examples section below. These examples are for illustration purposes only and are not intended to limit the scope of the present invention.

### EXAMPLES

### Materials and Methods

### Materials

Pea fiber material: Pea fiber 150M (Roquette Frères)
Commercial pea protein: different batches of Nutralys® S85F (Roquette Frères)
Pea flour: Flour obtained by dry grinding of dehulled yellow peas
Low methoxy pectin: CP Kelco GENU Explorer 30 CS-YA pectin
Locust bean gum: CP Kelco GENU GUM type RL-200 LBG

### Methods

### Determination of Total Fiber Content and Ethanol-Soluble Fiber SDFS:

The determination of total fiber content and ethanol soluble fiber SDFS is carried out according to the AOAC 2017.16 method. The residual ethanol soluble fiber is analyzed using the HPLC method below.

### Determination of the Amount of Saccharides Having a Degree of Polymerization of DP<10 by HPLC (% DP<10)

The high performance liquid chromatography system is composed of a pump of Waters M515 type, an automatic injector of Waters WISP type, a column thermostating oven set at 55° C., a differential refractometer of Waters R2414 type and a computer system equipped with software for processing the chromatograms, of Empower type (Waters). Two columns of ion-exchange resin in silver form, of Aminex HPX-42A Carbohydrate Column (300 mm×7.8 mm) type, mounted in series are used. The eluent used is distilled water (flow rate: 0.4 ml/minute). A sample of the solution of hydrolysate to be analyzed is prepared by diluting said solution with distilled water to approximately 5% solids, then by filtering it by passing it through a syringe equipped with a nozzle composed of a filtering membrane (porosity 0.45 μm). 20 μl of this solution are then injected into the apparatus for analysis.

### Determination of the Storage Modulus and the Gel Strength Ratio (TEST A)

The determinations of storage modulus (G′) after 1 hour of acidification (G′_{acid 1h}) of the pea protein composition and of the pea protein (a) allows to determine the gel strength ratio, which is calculated using the following equation:

$$gel strength ratio = ( {G}_{acid 1 h}^{′} ) of the pea protein composition / ( {G}_{acid 1 h}^{′} ) of the pea protein ( a ) .$$

To determine the storage modulus (G′), 30 g of dry protein product (dry protein (a) or dry protein composition) were dispersed at room temperature (around 22° C.) in 170 g of distilled water using a magnetic stirrer to produce a slurry having 15% of dry matter having a pH of 7. If the protein product is not neutral, a solution of HCl 1N or NaOH 1N partially replaces the water added in order that this slurry presents this pH of 7. A quantity of 0.02% sodium azide, expressed in dry weight, was added in the slurry to prevent bacterial growth. The slurries were stirred overnight to ensure complete hydration of the powders. After a duration of 12 hours, 2% glucono-delta-lactone (GDL) expressed in dry weight were added to the sample to slowly acidify the solutions to pH 4.6-4.8 over the course of several hours. The rheological properties (storage and loss moduli) were monitored maintaining the samples at 22° C. during acidification using a rheometer (Anton Parr Model MCR92) equipped with a concentric cylinder measuring system (CC39: cup diameter 42 mm; bob diameter 38.7 mm) that is filled with the recommended amount (approximately 65 g) applying a strain of 0.2% at a frequency of 1 Hz. The strain applied was within the linear viscoelastic region of the sample.

### Determination of the Percentage of Syneresis and the Syneresis Ratio (TEST B)

To determine the percentage of syneresis, 25 g of the GDL acidified solutions prepared in the same way than for TEST A were placed into a 50 mL centrifuge tube immediately after addition of GDL. The samples were incubated at 22° C. during 12 hours. Syneresis was measured by centrifuging at 1000×g for 10 minutes (Eppendorf 5810 centrifuge) and measuring the weight of the samples before and after decanting any liquid released by the gel during the centrifugation. Percent syneresis was calculated using the following equation:

$$\% syneresis = ( weight before removing expelled liquid - weight after removing expelled liquid ) \text{} / ( weight before removing expelled liquid ) * 100$$

$$Syneresis ratio = \% syneresis of the pea \text{} protein composition / \\ \% syneresis of the pea protein ( a ) .$$

Samples were measured in triplicate and reported as the average % syneresis and standard deviation.

### Example 1: Pea Protein Composition with Improved Acid Gelling Properties Obtained with a Pea Protein Obtained from Pea Flour

416 g of pea fiber material was combined with 4784 g water and stirred for 15 min to form a slurry. The slurry was then pH adjusted to pH 5 using 1N hydrochloric acid. The starting dry substance content of the pea fiber slurry was 7.9%. The pea fiber slurry was then cooked in an autoclave to a maximum temperature of 135° C. and held for 20 minutes before cooling to approximately 80° C. While still hot, the cooked slurry was separated by centrifuging at 3.000×g for 10 minutes in a Beckman Coulter Avanti JXN-26 centrifuge. The soluble liquid portion (supernatant) was retained while the insoluble pellet was discarded. The dry substance content of the liquid portion was 4.7% and the overall extraction yield of the soluble fraction was 59.7%. Extraction yield was measured using the following equation:

$$Extraction yield ( \% ) = ( dry substance of supernatant ) \text{} / ( dry substance of starting pea fiber slurry ) * 100$$

Pea protein was extracted by resuspending 4 kg of pea flour in 18 kg of 40° C. water and held for 20 minutes to allow for the extraction of soluble material. Starch and internal fiber were separated from the protein and other soluble solids by separation using a speed; 5 rpm differential speed; 60/10 wier disc). The starch rich underflow was discarded and the approximately 14 kg of protein rich overflow was pH adjusted to 5 using hydrochloric acid. After heat treatment at 60° C. for 10 minutes, the soluble material was removed from the acidified protein solution via the liquid overflow stream using a horizontal decanter centrifuge (Lemitec Laboratory Decanter MD80-Sn; 8000 rpm bowl speed; 7 rpm differential speed; 60/10 wier disc) while the protein was concentrated into the underflow. The collected underflow contained 31.9% dry substance and had a protein content of 86.1% on a dry weight basis. 772 g of protein rich underflow was blended with 208 g of cooked fiber soluble fraction to produce a dry matter ratio of 95:5 (protein solids:soluble cooked fiber solids). 3020 g water was also added and the mixture was neutralized to pH 7 using 1N sodium hydroxide. A control pea protein isolate sample was also prepared by combining 772 g of protein enriched underflow with 3228 g water. The co-product and control were both sheared using a high speed shear pump to disrupt any protein particles and heat treated using direct steam injection at 127° C. for 10 seconds with a flash temperature of 60° C. Samples were frozen in a −80° C. freezer overnight and freeze dried. Properties in the Table 1 demonstrate the improvements in the gel and syneresis properties.

TABLE 1
Summary of key rheological properties for acid
gels produced from either the control or the pea
protein composition sample of the invention.

| | G′ at | Gel | Syneresis | Syneresis |
|---|---|---|---|---|
| Sample | 60 min (Pa) | strength ratio | (%) | ratio |
| Control | 996 | 1 | 9.39 +/− 0.39 | 1 |
| Invention | 1448 | 1.45 | 5.26 +/− 0.14 | 0.56 |

### Example 2: Pea Protein Composition with Improved Acid Gelling Properties Obtained with a Commercial Pea Protein

Cooked pea fiber was produced in the same manner as described in Example 1 except that the acidified pea fiber slurry was cooked in an autoclave to a maximum temperature of 120° C. with a hold time of 20 minutes before cooling to approximately 80° C. Again the hot cooked fiber slurry was separated by centrifuging at 3.000×g for 10 min using a Beckman Coulter Avanti JXN-26 centrifuge. The insoluble pellet portion was discarded and the liquid supernatant soluble fraction (2.78% dry matter) was freeze dried to obtain the final cooked pea fiber. The overall extraction yield of the soluble fraction was 35%.

Commercial pea protein isolate was used as the protein source and the pea protein composition was obtained by dry blending 5% by weight of the final cooked pea fiber with 95% by weight of the pea protein composition, the percentages being expressed in dry weight.

Properties in the Table 2 also demonstrate the improvements in the gel and syneresis properties with a commercial pea protein isolate as a pea protein source.

TABLE 2
Summary of key rheological properties for acid gels produced
from either the control or co-product sample.

| | G′ at | Gel | Syneresis | Syneresis |
|---|---|---|---|---|
| Sample | 60 min (Pa) | strength ratio | (%) | ratio |
| Control | 449 | | 15.1 +/− 0.8 | |
| Co-Product | 829 | 1.85 | 9.1 +/− 0.3 | 0.60 |

### Example 3: Pea Protein Composition with Improved Acid Gelling Properties: Influence of the Spray Drying Method Vs Dry Blending

1.39 kg of pea fiber material was combined with 28.8 kg water and stirred for 15 min to form a slurry. The slurry was then pH adjusted to pH 5 using 3N hydrochloric acid. The dry substance of the pea fiber slurry was 4.2%. The pea fiber slurry was then cooked in a high-pressure reactor (Parr Instrument Company Series 8500 50 Liter Stirred Reactor System) to a maximum temperature of 135° C. and held for 20 minutes before cooling to approximately 90° ° C. While still hot, the cooked slurry was separated using a disc centrifuge (Alfa Laval Clara 20, 9.000 rpm bowl speed, 200 sec discharge time, 3.33 L/min feed rate). The soluble liquid fraction was retained while the insoluble pellet was discarded. The liquid portion contained 3.3% dry substance and had an extraction yield of 78.6%. A portion of the soluble liquid fraction was frozen overnight at −80° C. then freeze dried to provide dried cooked pea fiber and manufacture the pea protein composition by dry blending. The other portion was kept as is as cooked pea fiber to manufacture a powder of the pea protein composition by spray drying.

Pea protein was extracted by resuspending 5.8 kg of pea flour in 26.9 kg of 40° C. water and held for 10 minutes to allow for the extraction of soluble material. Starch and internal fiber were separated from the protein and other soluble solids by separation using a horizontal decanter centrifuge (Lemitec Laboratory Decanter MD80-Sn; 3000 rpm bowl speed; 5 rpm differential speed; 60/10 wier disc). The starch rich underflow was discarded and the approximately 21 kg of protein rich overflow was pH adjusted to 5 using hydrochloric acid. After heat treatment at 60° C. for 10 minutes, the soluble material was removed from the acidified protein solution via the liquid overflow stream using a horizontal decanter centrifuge (Lemitec Laboratory Decanter MD80-Sn; 8000 rpm bowl speed; 7 rpm differential speed; 60/10 wier disc) while the protein was concentrated into the underflow. The collected underflow contained 31.8% dry substance.

1043 g of protein rich underflow was blended with 709 g of liquid soluble fraction from cooked pea fiber to produce a dry matter ratio of 93.4:6.6 (protein solids:soluble cooked fiber solids). 1791 g water was also added and the mixture was neutralized to pH 7 using 3N sodium hydroxide (potassium hydroxide is also a suitable choice for neutralization). A control pea protein isolate sample was also prepared by combining 1000 g of protein enriched underflow with 1650 g water. The co-product and control were both sheared using a high-speed shear pump to disrupt any protein particles and heat treated using direct steam injection at 127° C. for 10 seconds hold time and a flash temperature of 60° C. Both the control and the co-product were spray dried with an inlet temperature of 210° C. and an outlet temperature of 80° ° C. to produce powders with a dry substance content of greater than 95% to produce a pea protein control and a spray dried pea protein composition.

The spray dried pea protein (the control of the experiment), was also dry blended with dried cooked pea fiber to provide dry blended pea protein composition and determine the influence of the method of drying.

Properties in the Table 3 also demonstrate the improvements in the gel and syneresis properties when using spray drying.

TABLE 3
Summary of key rheological properties for acid gels produced
from either the control or co-product sample.

| | G′ at | Gel | Syneresis | Syneresis |
|---|---|---|---|---|
| Sample | 60 min (Pa) | strength ratio | (%) | ratio |
| Control | 1819 | | 10.00 +/− 1.18 | |
| Spray Dried | 4574 | 2.51 | 2.68 +/− 0.79 | 0.27 |
| Pea protein | | | | |
| composition | | | | |
| Dry Blended | 4759 | 2.62 | 2.20 +/− 0.31 | 0.22 |
| pea protein | | | | |
| composition | | | | |

The results demonstrate that, when using spray drying, the same advantages can be obtained as when the pea protein composition is obtained by using freeze drying and dry blending.

### Example 4: The Influence of Cooking of Pea Fiber

Both whole and soluble cooked fiber were produced by combining 2 kg pea fiber material with 23 kg water. The slurry was stirred for 15 minutes then pH adjusted to 5 using 3N hydrochloric acid. The dry substance content of the pea fiber slurry was 7.9%. The acidified slurry was then cooked to 120° C. and held for 30 min in a high-pressure reactor (Parr Instrument Company Series 8500 50 Liter Stirred Reactor System) before cooling to 85° C. A portion of the cooked fiber slurry was frozen at −80° ° C. overnight then freeze dried (whole cooked fiber). The remaining of the cooked fiber slurry was separated while still hot by centrifuging at 3.000×g for 10 min using a Beckman Coulter Avanti JXN-26 centrifuge. The insoluble pellet portion was discarded and the liquid supernatant soluble fraction (5.9% dry substance; 74.6% extraction yield) was frozen at −80° C. overnight then freeze dried (soluble cooked fiber). Soluble uncooked pea fiber was prepared by combining 1 kg internal pea fiber with 5 kg water. The slurry was stirred for 15 minutes then pH adjusted to 5 using 3N hydrochloric acid. The dry substance content of the pea flour slurry was 16.4%. The slurry was then centrifuged at 5.000×g for 30 minutes using a Beckman Coulter Avanti JXN-26 centrifuge. The liquid supernatant fraction (soluble uncooked fiber) contained 1.25% dry substance (7.6% extraction yield) and was used as is for acid gel measurements. Pea fiber material was used for the whole uncooked fiber. Commercial pea protein isolate was used as the pea protein isolate.

Properties of the different uncooked and cooked fiber fractions are indicated in Table 4

TABLE 4
Yield, starch and fiber content for uncooked or
cooked, whole or soluble fraction of pea fiber.

| | | | % of total |
|---|---|---|---|
| | Yield | Total | starch which is |
| Sample | (%) | Starch (%) | gelatinized |
| Uncooked | | 38.8 | 17.9 |
| whole fiber | | | |
| Cooked | | 37.9 | 90.2 |
| whole fiber | | | |
| Uncooked | 74.6 | 16.3 | 96.1 |
| soluble fiber | | | |
| Cooked | 7.6 | 53.1 | 94.7 |
| soluble fiber | | | |

Acid gels were prepared from both the pea protein isolate alone and blends of pea protein isolate and whole cooked fiber, soluble cooked fiber, whole uncooked fiber, and soluble fraction of uncooked fiber at a 95:5 ratio (expressed in dry weight) and results are reported in Table 5 below.

TABLE 5
Summary of key rheological properties for acid gels produced
from control and uncooked whole fiber, uncooked soluble fiber,
cooked whole fiber, and cooked soluble fiber co-products.

| | | Gel | | |
|---|---|---|---|---|
| | G′ at | strength | Syneresis | Syneresis |
| Sample | 60 min (Pa) | ratio | (%) | ratio |
| Control | 1332 | | 17.14 +/− 0.31 | 1 |
| Uncooked | 923 | 0.69 | 14.11 +/− 3.73 | 0.82 |
| Whole Fiber Co- | | | | |
| Product | | | | |
| Uncooked | 148 | 0.11 | Sample did not | Not |
| Soluble Fiber | | | gel, not measured | Measured |
| Co-Product | | | | |
| Cooked Whole | 1749 | 1.31 | 6.46 +/− 0.37 | 0.38 |
| Fiber Co- | | | | |
| Product | | | | |
| Cooked Soluble | 1888 | 1.42 | 8.14 +/− 1.27 | 0.47 |
| Fiber Co- | | | | |
| Product | | | | |

It should be noted from Table 5 that the soluble fraction of uncooked pea fiber and uncooked pea fiber did not improve the gel properties of the pea protein, despite the same acidification as the control and other co-products. There was a 31% decrease in gel strength for the uncooked whole fiber co-product but a 31% increase in gel strength for the cooked whole fiber co-product and a 42% increase in gel strength for the cooked soluble fiber co-product compared to the control. Additionally, there was a small decrease of the syneresis of 18% in the case of incorporation of whole pea fiber, whereas the syneresis dramatically decreases with cooked pea fiber (respectively 62% and 53% for the cooked whole fiber and cooked soluble fiber) compared to the control.

### Example 5: The Influence of Pea Fiber Cooking Conditions

Whole cooked pea fiber and soluble cooked pea fiber were produced by combining 2 kg pea fiber material with 23 kg water. The slurry was stirred for 15 min then pH adjusted to 5 using 3N hydrochloric acid. The dry substance content of the fiber slurry was 7.36%. The acidified slurry was then cooked to 120° C. and held for 30 min in a high-pressure reactor (Parr Instrument Company Series 8500 50 Liter Stirred Reactor System) before cooling the sample to 85° C. and removing a portion (120° C./30 min). The remaining sample was reheated to 120° C. and held for an additional 30 minutes then cooled to 85° C. and a portion removed (120° C./60 min). This reheating to 120° C., holding for 30 minutes then cooling to 85° C. and removing a portion of the sample was repeated two additional times to produce samples 120° C./90 min and 120° C./120 min. A portion of the cooked fiber samples were frozen at −80° C. overnight then freeze dried. A second portion of each cooked fiber sample was centrifuged while still hot at 3.000×g for 10 minutes using a Beckman Coulter Avanti JXN-26 centrifuge. The insoluble portion of each sample was discarded and the liquid soluble portion frozen at −80° C. overnight then freeze dried. Finally, a third portion of each cooked fiber sample was placed in the refrigerator for 12 hours to allow the gelatinized starch to retrograde. The sample was centrifuged cold at 3.000×g for 10 min using a Beckman Coulter Avanti JXN-26 centrifuge. Again the soluble liquid portion was freeze dried and the solid insoluble portion was discarded. In this third version of the cooked pea fiber, there is thus a further removal of starch. Indeed, the retrogradation of the starch fraction of the cooked pea fiber allows the further removal of the starch in the cooked pea fiber. The method is called cold extraction in the Table 6 and sample is called “cold soluble” in Table 7. The dry substance and extraction yield for the 8 soluble cooked pea fiber samples are listed in Table 6. There was the general trend that the longer the cook time at 120° C., the greater the dry substance of the resulting soluble fractions and the greater the extraction yield. Extraction yield was calculated as: (% dry substance of soluble fraction)/% dry substance of uncooked pea fiber slurry)*100

TABLE 6
Dry substance and extraction yield for soluble fiber
samples cooked form increasing times at 120° C.

| | | Extraction | Dry substance | Extraction |
|---|---|---|---|---|
| | | Yield for | for cold | yield cold |
| Cook Time | Dry Substance | separation | separation | separation |
| at 120° C. | for separation | soluble | soluble | soluble |
| (min) | soluble fraction | fraction | fraction | fraction |
| 30 | 5.65 | 76.8 | 3.17 | 43.1 |
| 60 | 5.79 | 78.7 | 3.43 | 46.6 |
| 90 | 5.99 | 81.4 | 3.75 | 51.0 |
| 120 | 5.85 | 79.5 | 3.98 | 54.1 |

Acid gels were prepared from the commercial pea protein isolate alone and blends of commercial pea protein and each of the whole cooked fiber, and soluble cooked fiber and cold soluble cooked fiber samples (120° C./30 min, 120° C./60 min, 120C/° 90 min and 120° C./120 min) at a 95:5 ratio.

TABLE 7
Composition of cooked fiber samples (and soluble fractions)
cooked at 120° C. for either 30 or 120 minutes.

| | | % Starch | % ethanol- | |
|---|---|---|---|---|
| Cook time | | (dry weight | soluble fiber | DP < 10 |
| at 120° C. | Fraction | basis, dwb) | SDFS | (%) |
| Uncooked | Whole | 39.3 | 1.8 | 4.99 |
| 30 | Whole | 31.0 | <0.1% | 22.53 |
| 30 | soluble | 47.1 | 4.6 | 17.28 |
| 30 | Cold soluble | 2.5 | 6.4 | 16.38 |
| 120 | Whole | 31.2 | 10.2 | 4.67 |
| 120 | soluble | 43.5 | 11.5 | 8.31 |
| 120 | Cold soluble | 20.0 | 16.4 | 5.94 |

TABLE 8
Summary of key rheological properties for acid gels produced from
pea protein control, and whole cooked fiber, soluble cooked fiber
and cold soluble cooked fiber pea protein co-products.

| | | Gel | | | |
|---|---|---|---|---|---|
| | | strength | Gel | | |
| Cook time | | at 60 min | strength | Syneresis | Syneresis |
| at 120° C. | Fraction | (Pa) | ratio | (%) | ratio |
| N/A | Control pea | 612 | | 11.06 | |
| | protein isolate | | | | |
| 30 | Whole | 1198 | 1.96 | 8.6 | 0.78 |
| 30 | soluble | 1178 | 1.92 | 9.19 | 0.83 |
| 30 | Cold soluble | 1228 | 2.01 | 17.83 | 1.61 |
| 60 | Whole | 1143 | 1.87 | 10.29 | 0.93 |
| 60 | soluble | 1052 | 1.72 | 11.96 | 1.08 |
| 60 | Cold soluble | 912 | 1.49 | 19.84 | 1.79 |
| 90 | Whole | 930 | 1.52 | 10.38 | 0.94 |
| 90 | soluble | 1119 | 1.83 | 9.16 | 0.83 |
| 90 | Cold soluble | 791 | 1.29 | 19.22 | 1.74 |
| 120 | Whole | 593 | 0.97 | 14.33 | 1.30 |
| 120 | soluble | 794 | 1.30 | 12.24 | 1.11 |
| 120 | Cold soluble | 849 | 1.39 | 16.37 | 1.48 |

As a general trend, the gel strength ratio is greatest and the syneresis ratio is the lowest for cooked fiber samples cooked at 120° C. for 30 minutes. Longer cooking times result in a lower gel strength ratio (and for some samples a ratio <1 indicating that the addition of the cooked fiber sample interferes with acid gel formation compared to the control pea protein isolate alone) and an increased syneresis ratio indicating that these cooked fiber samples are not as effective at improving the acid gel strength of pea protein isolate. In these series of tests, the removal of starch from the cooked pea fiber by cold separation was most generally favorable for the gel strength but detrimental for the syneresis properties.

### Example 6: Influence of the Ratio Pea Protein Isolate/Cooked Pea Fiber

Cooked pea fiber was produced by combining 2 kg pea fiber material with 23 kg water. The slurry was stirred for 15 min then pH adjusted to 5 using 3N hydrochloric acid. The acidified slurry was then cooked to 120° C. and held for 30 min in a high-pressure reactor (Parr Instrument Company Series 8500 50 Liter Stirred Reactor System) before removing at 85° C. The whole cooked fiber slurry was frozen at −80° C. overnight then freeze dried. Commercial pea protein isolate was used as the protein source.

Acid gels were prepared from the pea protein isolate alone and blends of pea protein isolate and the whole cooked fiber at protein powder:fiber powder ratios of 95:5, 90:10, and 80:20.

TABLE 9
Summary of key rheological properties for acid gels produced from
control and co-products comprising pea protein isolate and pea
fiber cooked at 120° C./30 min at 95:5, 90:10, and 80:20 ratios.

| | | Gel | | |
|---|---|---|---|---|
| | G′ at 60 | strength | Syneresis | Syneresis |
| Sample | minutes (Pa) | ratio | (%) | ratio |
| Control | 1332 | | 17.14 +/− 0.31 | |
| 95:5 Co- | 1749 | 1.31 | 6.46 +/− 0.37 | 0.38 |
| Product | | | | |
| 90:10 Co- | 2152 | 1.62 | Not measured | Not measured |
| Product | | | | |
| 80:20 Co- | 2298 | 1.73 | Not measured | Not measured |
| Product | | | | |

Table 9 shows that there was a 31%, 62%, and 73% increase in gel strength for the co-products (at 95:5, 90:10, and 80:20 protein solids: whole cooked fiber solids respectively) compared to the control. Additionally, there was a 62% decrease in syneresis for the 95:5 co-product compared to the control.

### Example 7: Manufacturing of Spray Dried Powder of Pea Protein Composition with Improved Acid Gelling Properties at Pilot Scale

800 g of pea fiber material was combined with 9.2 kg water and stirred for 15 min to form a slurry. The slurry was then pH adjusted to pH 5 using 3N hydrochloric acid. The pea fiber slurry was then cooked in a high-pressure reactor (Parr Instrument Company Series 8500 50 Liter Stirred Reactor System) to a maximum temperature of 120° C. and held for 20 minutes before cooling to approximately 90° C. The dry substance content of the cooked pea fiber was 7.2%.

Pea protein was extracted by resuspending 20.8 kg of pea flour in 93.2 kg of 40° C. water and held for 10 minutes to allow for the extraction of soluble material. Starch and internal fiber were separated from the protein and other soluble solids by separation using a horizontal decanter centrifuge (Lemitec Laboratory Decanter MD80-Sn; 5500 rpm bowl speed; 20 rpm differential speed; 60/10 wier disc). The starch rich underflow was discarded and the approximately 30 kg of protein rich overflow was pH adjusted to 5 using hydrochloric acid. After heat treatment at 55° C. for 20 minutes, the soluble material was removed from the acidified protein solution via the liquid overflow stream using a horizontal decanter centrifuge (Lemitec Laboratory Decanter MD80-Sn; 8000 rpm bowl speed; 7 rpm differential speed; 60/10 wier disc) while the protein was concentrated into the underflow. The collected underflow was diluted with water to a dry substance content of 21.7%.

9.8 kg of protein rich underflow was blended with 1.4 kg of cooked pea fiber to produce a dry matter ratio of 95.5:4.5 (protein solids: whole cooked fiber solids). 7.5 kg water was also added and the mixture was neutralized to pH 7 using 3N sodium hydroxide (potassium hydroxide is also a suitable choice for neutralization). A control pea protein isolate sample was also prepared by combining 1 kg of protein enriched underflow with 1.6 kg water. The co-product and control were both sheared using a high-speed shear pump to disrupt any protein particles and heat treated using direct steam injection at 127° C. for 10 seconds hold time and a flash temperature of 60° C. Both the control and the co-product were spray dried with an inlet temperature of 210° C. and an outlet temperature of 80° C. to produce powders with a dry substance content of greater than 95%.

Acid gels were prepared from the control pea protein isolate and the co-product.

TABLE 10
Summary of key rheological properties for acid gels produced
from control and co-products comprised of spray dried
cooked whole pea fiber and pea protein isolate.

| | | Ratio Co- | | |
|---|---|---|---|---|
| | G′ at 60 | Product/ | Syneresis | Syneresis |
| Sample | minutes (Pa) | Control | (%) | ratio |
| Control | 2208 | | 7.53 +/− 1.34 | |
| Co-Product | 5427 | 2.46 | 0.40 +/− 0.06 | 0.05 |

The gel strength of the spray-dried co-product was 146% increased compared to the control while there was a 95% decrease in syneresis for the co-product compared to the control.

### Example 8: Impact of Protein Heat Treatment on Acid Gel Strength and Improvement Upon Adding Cooked Pea Fiber

Pea protein was extracted by resuspending 4 kg of pea flour in 18 kg of 22° C. water and held for 20 minutes to allow for the extraction of soluble material. Starch and internal fiber were separated from the protein and other soluble solids by separation using a speed; 5 rpm differential speed; 60/10 wier disc). The starch rich underflow was discarded and the approximately 14 kg of protein rich overflow was pH adjusted to 5 using hydrochloric acid and divided into 3 equal volumes.

The first portion was immediately centrifuged at 3,000×g for 15 min at 22° C. using a Beckman Coulter Avanti JXN-26 centrifuge. The protein rich pellet was resuspended in water to 15% total solids and the pH was neutralized to 7 using 3N NaOH. The neutralized material was sheared using a high speed shear pump to break up any protein particles. The pH of the sample was readjusted to 7 before freeze drying. This pea protein is prepared as described in document U.S. Pat. No. 8,124,162 B2 (without additional thermal treatment).

The second portion was heated to 60° C. for 10 minutes before being centrifuged at 3,000×g for 15 min at 22° C. using a Beckman Coulter Avanti JXN-26 centrifuge. The protein rich pellet was resuspended in water to 15% total solids and the pH was neutralized to 7 using 3N NaOH. The neutralized material was sheared using a high speed shear pump to break up any protein particles. The pH of the sample was readjusted to 7 before freeze drying. This pea protein is prepared as described in document U.S. Pat. No. 8,124,162 B2 (with additional thermal treatment).

The third portion was heated to 60° C. for 10 minutes before being centrifuged at 3,000×g for 15 min at 22° C. using a Beckman Coulter Avanti JXN-26 centrifuge. The protein rich pellet was resuspended in water to 15% total solids and the pH was neutralized to 7 using 3N NaOH. The neutralized material was sheared using a high speed shear pump to break up any protein particles. The pH of the sample was readjusted to 7 then heated to 85° C. for 10 minutes to denature the protein before freeze drying.

Differential scanning calorimetry was conducted on resuspended samples of these 3 pea protein isolates to determine the impact of the various heat treatments on the denaturation of the protein. 10% protein solutions were prepared using deionized water. 34-36 mg of each slurry was placed in a hermetically sealed high volume stainless steel pan and heated from 5° C. to 150° C. at a heating rate of 10° C./min in a TA Instruments Discovery DSC250. The denaturation onset and peak temperatures were recorded, and the denaturation enthalpy was calculated using Trios software.

TABLE 11
Differential Scanning Calorimetry parameters for pea
protein isolates exposed to various heat treatments.

| | | Onset | Peak | |
|---|---|---|---|---|
| Protein | Heat | Temperature | Temperature | Enthalpy |
| Sample | Treatment | (° C.) | (° C.) | (J/g) |
| 1 | None | 74.52 | 86.57 | 0.44 |
| 2 | 60° C./10 min | 74.6 | 86.48 | 0.469 |

| | | |
|---|---|---|
| 3 | 60° C./10 min + | No denaturation peak detected |
| | 85° C./10 min | |

Based on the DSC analysis, the 60° C./10 min heat treatment did not cause denaturation of the proteins but instead served to assist flocculation during the isoeletric precipitation step. However, heat treatment at 85° C./10 min did cause denaturation of the proteins as no peak was detected during the DSC analysis.

160 g of pea fiber material was combined with 1840 g water and stirred for 15 min to form a slurry. The slurry was then pH adjusted to pH 5 using 1N hydrochloric acid. The starting dry substance content of the pea fiber slurry was 7.8%. The pea fiber slurry was then cooked in an autoclave to a maximum temperature of 120° C. and held for 20 minutes. After cooling the sample was freeze dried. Co-products were formed by dry blending protein powder and fiber powder at a ratio of 95:5.

Acid gels were prepared from the control pea protein isolate and the co-product.

TABLE 12
Summary of key rheological properties for acid gels produced from
control and co-products comprised of dry blended cooked pea fiber
and pea protein isolates exposed to various heat treatments.

| | | Ratio Co- | | |
|---|---|---|---|---|
| | G′ at 60 | Product/ | Syneresis | Syneresis |
| Sample | minutes (Pa) | Control | (%) | ratio |
| Protein 2 | 123.3 | | 13.9 | |
| control | | | | |
| Protein 2 co- | 207.7 | 1.68 | 11.2 | 0.8 |
| product | | | | |
| Protein 3 | 647.7 | | 6.3 | |
| control | | | | |
| Protein 3 co- | 1992.4 | 3.08 | 2.0 | 0.32 |
| product | | | | |

For the protein exposed to a 60° C./10 min heat treatment that is not denaturated, the gel strength of the co-product was 68.5% increased compared to the control while there was a 20% decrease in syneresis for the co-product compared to the control. For the protein exposed to both a 60° C./10 min and an 85° C./10 min heat treatments and that is denaturated, the gel strength of the co-product was even higher: it was over 200% increased compared to the control while there was a 68% decrease in syneresis for the co-product compared to the control.

### Example 9: Impact of Pea Fiber Cook pH on Improvement of Pea Protein Isolate Gel Strength

Cooked pea fiber was produced by combining 480 g pea fiber material with 5520 g water. The slurry was stirred for 15 min then divided into 3 equal volumes. One sample was pH adjusted to 5 using 1N hydrochloric acid, the second sample was adjusted to pH 7 using 1N NaOH, and the final sample was pH adjusted to 9 using 1N NaOH. The slurries were then cooked to 120° C. and held for 20 min in an autoclave. After cooling, the whole cooked fiber slurries were frozen at −80° ° C. overnight then freeze dried. Commercial pea protein isolate was used as the protein source.

Acid gels were prepared from the pea protein isolate alone and blends of pea protein isolate and the whole cooked fiber at a protein powder:fiber powder ratio of 95:5.

TABLE 13
Summary of key rheological properties for acid gels produced
from control and co-products comprising pea protein isolate
and pea fiber cooked at 120° C./20 min at pH 5, 7 or 9.

| | | Gel |
|---|---|---|
| | G′ at 60 | strength |
| Sample | minutes (Pa) | ratio |
| Control | 900 | |
| pH 5 fiber Co- | 1666 | 1.85 |
| Product | | |
| pH 7 fiber Co- | 1619 | 1.80 |
| Product | | |
| pH 9 fiber Co- | 1605.2 | 1.78 |
| Product | | |

Table 13 shows that there was a similar increase (85%, 80% and 78%) in gel strength for the co-products (with pea fiber cooked at pH 5, 7 or 9) compared to the control.

### Example 10: Improved Acid Gel Properties of Leguminous Protein Composition (Soy Protein Isolate+Cooked Pea Fiber)

Cooked pea fiber was produced by combining 480 g pea fiber material with 5520 g water. The slurry was stirred for 15 min, pH adjusted to 5 using 1N HCl and cooked in an autoclave at 120° C. for 20 minutes. After cooling, the whole cooked fiber slurries were frozen at −80° C. overnight then freeze dried. Commercial soy protein isolate (Solpy 6000H Nishin Oillio) was used as the protein source.

Acid gels were prepared from the soy protein isolate alone and blend of soy protein isolate and the whole cooked fiber at a protein powder:fiber powder ratio of 95:5. On the contrary to what was observed with pea proteins, the gels of soy protein and blend after 60 minutes were still not developed (G′ was less than 100 Pa). Thus, the gel strength G′ reported in Table below is the value reported after 180 minutes instead of 60 minutes.

TABLE 14
Summary of key rheological properties for acid gels produced
from soy protein control and co-product comprising soy protein
isolate and pea fiber cooked at 120° C./20 min at pH 5.

| | | Gel |
|---|---|---|
| | G' at 180 | strength |
| Sample | minutes (Pa) | ratio |
| Control | 2040 | |
| Co-product | 2515.1 | 1.23 |

Table 14 shows that there was a 23% increase in gel strength when soy protein isolate was combined with cooked pea fiber.

### Example 11: Replacement of Low Methoxy Pectin by Cooked Fiber in Stirred Yogurts

Plant-based yogurt alternatives rely on the use of polysaccharides such as pectin to improve viscosity. The ability of a co-product containing pea protein isolate and cooked pea fiber to replace those additional ingredients can be advantageous solutions compared to the use of this additive.

In this example, the pea protein composition of the invention is incorporated in the yogurt model system by incorporation separately the pea protein isolate and the cooked pea fiber.

A yogurt model system was used to demonstrate the ability of a soluble fraction of pea fiber cooked at 135° C. for 20 minutes to replace low methoxy pectin. The soluble fraction of cooked fiber fraction was prepared as described in Example 1 and used as a freeze dried powder in the yogurt model system.

TABLE 15
Formulations (values are % of total
formula) for the yogurt model system.

| | | | Soluble |
|---|---|---|---|
| | | | Cooked |
| Ingredient | Control | Pectin | Fiber |
| Water | 82.47 | 82.47 | 82.47 |
| Sucrose | 5.20 | 4.60 | 4.60 |
| Pea Protein Isolate | 10.13 | 10.13 | 10.13 |
| Coconut Oil | 2 | 2 | 2 |
| Locust Bean Gum | 0.20 | 0.20 | 0.20 |
| Low-Methoxy Pectin | 0 | 0.60 | 0 |
| Soluble Cooked | 0 | 0 | 0.60 |
| Fiber Fraction | | | |

The yogurt model system was produced by hydrating the pea protein isolate with approximately ⅔ of the total amount of water pre-heated to 60° C. using a temperature controlled mixer (Thermomix Model TM6). The sucrose was dry blended with locust bean gum and pectin or soluble cooked fiber fraction then hydrated in the remaining water preheated to 60° C. using either high shear (Fisherbrand 850 homogenizer) for the pectin sample or moderate shear (Fisherbrand Overhead Mixer) for the soluble fiber fraction and control samples. Coconut oil was melted and added to the pre-hydrated pea protein using high shear (Thermomix Model TM6) and finally the sucrose/locust bean gum/pectin or cooked fiber slurry was added under high shear. After mixing all ingredients, the sample was heated to 90° C. for 3 min before cooling to 25° C.

Once cooled, 1.75% glucono-delta-lactone was added to the mixtures and the samples were acidified at 22-25° C. for 4 hours. The pH was decreased from 7.2 to 4.8 during these 4 hours. The acidified sample was mixed using a Hobart stand mixer equipped with a paddle attachment and characterization containers (conical centrifuge tubes and glass jars) were filled and placed in refrigeration overnight.

TABLE 16
pH values after 4 hr and overnight acidification
for yogurt model system samples.

| | pH after | pH after |
|---|---|---|
| | 4 hrs | overnight |
| | acidification | acidification |
| Sample | at 22-25° C. | at 4° C. |
| Control | 4.78 | 4.51 |
| Pectin | 4.81 | 4.53 |
| Soluble Cooked Fiber | 4.82 | 4.58 |

After overnight refrigeration, samples were measured for syneresis by centrifuging the samples stored in conical tubes at 2,000×g for 10 min using an Eppendorf Model 5810 centrifuge and gel firmness by texture analysis using a TA.XTplus texture analyzer equipped with a one inch acrylic cylinder probe. The texture analyzer program was adapted from the TA.XTplus Application Study: Yogurts Tested Three Ways; 1 mm/second pre-test speed, 2 mm/second test speed, and 2 mm/second test speed. The trigger was set at 5 grams with a target distance of 15 mm. Hardness was calculated as the max force detected during the measurement.

TABLE 17
Syneresis and gel firmness values for yogurt model systems made
using either low-methoxy pectin or soluble cooked fiber fraction.

| | | | Ratio Co- |
|---|---|---|---|
| | Syneresis | Hardness | Product/ |
| | (%) | (g) | Control |
| Control | 0.39 | 202.3 | |
| Pectin | 1.53 | 207.2 | 1.0 |
| Soluble Fiber | 0 | 241.0 | 1.2 |
| Fraction | | | |

Table 17 shows there was a 20% increase in gel strength and a 100% decrease in syneresis for the yogurt containing the cooked soluble fiber fraction compared to the control. However for the yogurt sample containing low methoxy pectin there was no increase in gel strength and a 292% increase in syneresis compared to the control. This demonstrates the advantage of the using cooked pea fiber in a pea protein composition in that it can give even better texture than the pectin-based yogurt.

### Example 12: Replacement of Low Methoxy Pectin and Locust Bean Gum with Cooked Pea Fiber in Direct Set and Stirred Yogurt

Plant-based yogurt alternatives also rely on the use of polysaccharides such as locust bean gum for syneresis control. The ability of cooked pea fiber to replace those additional ingredients, as a co-product with pea protein, can be advantageous solutions compared to the use of this additive.

To investigate the ability of the cooked pea fiber to replace both locust bean gum and pectin, yogurt model systems were produced using the following formulas outlined in Table 18.

TABLE 18
Yogurt model system formulas with removal of locust bean gum.

| | | Soluble fraction |
|---|---|---|
| Ingredient | Control | of cooked Fiber |
| Water | 82.47 | 82.47 |
| Sucrose | 5.40 | 4.80 |
| Pea Protein Isolate | 10.13 | 10.13 |
| Coconut Oil | 2 | 2 |
| Soluble Pea Fiber | 0 | 0.60 |
| Fraction | | |

Soluble cooked fiber was prepared as described in Example 1. Pea Protein Isolate was commercial pea protein.

Samples were prepared and acidified in the same manner as Example 11. Samples were either poured directly into characterization containers immediately after adding GDL and placed in the refrigerator overnight (direct set yogurt model) or stirred after 4 hours of acidification at 22-25° C., poured into characterization containers then placed in the refrigerator overnight (stirred yogurt model). Table 19 shows the values for syneresis and gel firmness.

TABLE 19
Syneresis and gel firmness values for stirred and set yogurt model systems 18..

| | Direct set | Ratio Co- | Direct set | Stirred | Ratio Co- | Stirred |
|---|---|---|---|---|---|---|
| | Hardness | product/ | syneresis | Hardness | product/ | syneresis |
| Sample | (g) | Control | (%) | (g) | control | (%) |
| Control | 515 | | 1.90 | 176 | | 5.44 |
| Co-Product | 732 | 1.4 | 0.97 | 215 | 1.2 | 4.55 |

There was a 40% increase in gel strength and a 49% decrease in syneresis when the soluble fraction of cooked fiber fraction was used in a direct set yogurt model system. Similarly, there was a 20% increase in gel strength and a 16% decrease in syneresis when the soluble cooked fiber fraction was used in the stirred yogurt model system.

### Example 13: Yogurt Made with Pea Protein Compositions Manufactured at Pilot Scale

In this example, the pea protein composition and the pea protein isolate are prepared at pilot scale in the same way as described in Example 7. The composition of these are reported in Table 20.

TABLE 20
Composition of control pea protein isolate and co-product
comprising pea protein isolate and cooked pea fiber.

| | Dry | | | Total |
|---|---|---|---|---|
| | Substance | Protein | Starch | Dietary Fiber |
| Sample | (%) | [dwb] (%) | [dwb] (%) | [dwb] (%) |
| Control | 96.3 | 84.8 | 0.5 | 6.7 |
| Co-product | 97.9 | 82.1 | 2.0 | 10.2 |

Yogurt model system samples (both direct set and stirred) were produced to compare the control pea protein isolate+pectin to the co-product containing cooked pea fiber according to Table 21.

TABLE 21
Yogurt model system formulas without locust bean gum.

| | | Co- |
|---|---|---|
| Ingredient | Control | Product |
| Water | 82.47 | 82.47 |
| Sucrose | 4.80 | 5.40 |
| Pea Protein Isolate | 10.13 | 0 |
| Control | | |
| Pea Protein | 0 | 10.13 |
| composition of | | |
| invention | | |
| Coconut Oil | 2 | 2 |
| Pectin | 0.60 | 0 |

Both direct set and stirred samples were produced as described in Example 11. Table 22 shows the values for syneresis and gel firmness.

TABLE 22
Syneresis and gel firmness values for stirred and direct set yogurt model systems.

| | Direct set | Ratio Co- | Direct set | Stirred | Ratio Co- | Stirred |
|---|---|---|---|---|---|---|
| | Hardness | product/ | syneresis | Hardness | product/ | syneresis |
| Sample | (g) | Control | (%) | (g) | control | (%) |
| Control | 846 | | 12.9 | 57 | | 14.9 |
| Co-Product | 1057 | 1.25 | 0.7 | 202 | 3.54 | 3.8 |

There was a 25% increase in gel strength and a 95% decrease in syneresis for the direct set yogurt made with the co-product compared to the control+pectin. Additionally, there was a 254% increase in gel strength and a 74% decrease in syneresis for the stirred yogurt made with the co-product compared to the control+pectin.

### Example 14 Yogurts Made with Pea Protein Compositions Manufactured at Pilot Scale

Control and Co-Product pea protein isolates were produced as described in Example 7. Direct set and stirred yogurt model systems were produced as described in Example 12 using the formula outlined in Table 23.

TABLE 23
Yogurt model system formulas without locust bean gum and
without the addition of pectin to the control samples.

| Ingredient | Control | Co-Product |
|---|---|---|
| Water | 82.47 | 82.47 |
| Sucrose | 5.40 | 5.40 |
| Pea Protein Isolate | 10.13 | 0 |
| Control | | |
| Pea Protein Isolate | 0 | 10.13 |
| Co-Product | | |
| Coconut Oil | 2 | 2 |

TABLE 23
Syneresis and gel firmness values for stirred and set yogurt model systems.

| | Direct set | Ratio Co- | Direct set | Stirred | Ratio Co- | Stirred |
|---|---|---|---|---|---|---|
| | Hardness | product/ | syneresis | Hardness | product/ | syneresis |
| Sample | (g) | Control | (%) | (g) | control | (%) |
| Control | 530 | | 0.23 | 125 | | 10.36 |
| Co-Product | 618 | 1.17 | 0.10 | 197 | 1.58 | 1.68 |

There was a 17% increase in gel strength and a 57% decrease in syneresis for the direct set yogurt made with the co-product compared to the control. Additionally, there was a 58% increase in gel strength and an 84% decrease in syneresis for the stirred yogurt made with the co-product compared to the control.

All results demonstrate that the pea protein composition allow to obtain acid gel forming yogurts having improved texture compared to pea protein isolate alone, and this even without using additives that are generally used in these kinds of products, such as pectins or locust gum.

1) A process of manufacturing a leguminous protein composition comprising:
providing a leguminous protein (a),
providing a cooked leguminous fiber (b),
blending the cooked leguminous fiber (b) with the leguminous protein (a) to form the leguminous protein composition,
wherein the weight ratio a:b in dry weight ranges from 99:1 to 80:20.

2) The process of claim 1 wherein the cooked leguminous fiber (b) is obtained by a process comprising a step of cooking a suspension of a leguminous fiber material, preferably at a temperature comprised between 60 and 200° c., even more preferably between 120° C. and 135° C.

3) The process of claim 2 wherein the suspension has a pH between 4 and 6, preferably between 4.5 and 5.5.

4) The process of claim 2 wherein, the cooked leguminous fiber (b) is obtained by a process comprising, after the step of cooking, a step of removing the insoluble fraction from the cooked leguminous fiber, for example using decantation, centrifugation or filtration, advantageously using centrifugation.

5) The process of claim 1 wherein the cooked leguminous fiber b) has an ethanol-soluble fiber residue as determined by AOAC-2017.16 fiber determination assay, comprising an amount of saccharides having a degree of polymerization of DP<10, expressed in dry mass content based on the total dry mass of the ethanol-soluble fiber residue, above 6%, or from 10 to 50%, or from 10 to 40%, or from 10 to 35%, or from 12 to 30%, or from 15 to 25%.

6) The process of claim 1 wherein the cooked leguminous fiber (b) comprises an amount of gelatinized starch, based on the total weight of starch of the cooked leguminous fiber, of at least 80%, for example of at least 90% and comprises an amount of ethanol-soluble fiber, as determined by AOAC 2017-16, below 20%, for example below 9%, for example below 7%, for example below 5%, for example below 3%.

7) The process of claim 1 wherein the blending step is performed by dry blending a powder of the leguminous protein (a) and a powder of the cooked leguminous fiber (b).

8) The process of claim 1 wherein the blending step is performed by co-atomization of a liquid containing the protein (a) and a liquid containing the cooked leguminous fiber (b) or by atomization of a liquid containing the leguminous protein (a) and the cooked leguminous fiber (b).

9) The process of claim 1 wherein the leguminous protein (a) has a degree of hydrolysis below 6, for example between 3 and 5.5.

10) The process of claim 1 wherein the weight ratio a:b expressed in dry weight, is between 97:3 and 87:13, preferably between 95:5 and 90:10.

11) The process of claim 1 wherein the leguminous is pea.

12) A leguminous protein composition obtainable by the process of claim 1.

13) A leguminous protein composition wherein said leguminous protein composition has:
i) a richness in proteins, on a dry weight basis, above 75%
ii) a total starch content going from O to 10%, for example from 0.5 to 5%,
iiii) a total dietary fiber content going from 0 to 20%, for example from 5 to 15%, as determined using the AOAC Method 2017.16, and
iv)
a storage modulus of at least 1000 Pa, preferably at least 2500 Pa when determined using TEST A, advantageously at least 3000 Pa, preferably at least 3500 Pa, more preferably at least 4000 Pa, even more preferably at least 4500 Pa, most preferably at least 5000 Pa and/or
a percentage of syneresis below 7% when determined using TEST B, advantageously below 5%, preferably below 4%, more preferably below 3%, even more preferably below 2%, most preferably below 1%.

14) A leguminous protein composition wherein said leguminous protein composition has:
i) a richness in proteins, on a dry weight basis, above 75%
ii) a total starch content going from Oto 10%, for example from 0.5 to 5%,
iii) a total dietary fiber content going from 0 to 20%, for example from 5 to 15%, as determined using the AOAC Method 2017.16, and
iv) comprises a blend of a leguminous protein (a) and a cooked leguminous fiber (b) wherein the weight ratio a:b in dry weight ranges from 99:1 to 80:20.

15) A leguminous protein composition according to claim 14 wherein:
the cooked leguminous fiber b) has an ethanol-soluble leguminous fiber residue, as determined by AOAC-2017.16 fiber determination assay, with a content of saccharides having a degree of polymerization of DP<10, expressed in dry mass content, above 6%, or from 10 to 50%, or from 10 to 40%, or from 10 to 35%, or from 12 to 30%, or from 15 to 25%,
and/or
wherein the cooked leguminous fiber (b) has a content of gelatinized starch, based on the content of starch of the cooked leguminous fiber, of at least 80%, for example of at least 90% and a content of ethanol-soluble fiber residue, as determined by AOAC 2017-16, below 20%, for example below 9%, for example below 7%, for example below 5%, for example below 3%.

16) The leguminous protein composition from claim 12 wherein the leguminous is pea.

17) Use of the composition of claim 12 in acid-gelling food products.
